(19) United States
(12) Patent Application Publication
(10) Pub. No.: US 2026/0269583 A1
(43) Pub. Date: Sep. 10, 2026

(54) HARNESS SUPPORT FOR A WASHING MACHINE APPLIANCE

(71) Applicant: Haier US Appliance Solutions, Inc., Wilmington, DE (US)

(72) Inventor: Bryan James Beckley, Crestwood, KY (US)

(21) Appl. No.: 19/070,715

(22) Filed: Mar. 5, 2025

(51) Int. Cl. H02G 3/04; D06F 34/08

(52) U.S. Cl. CPC H02G 3/0456; D06F 34/08

(57) ABSTRACT

A system for supporting a harness including a wiring harness in a domestic appliance. The domestic appliance includes a wash tub, an electrical component mounted to the wash tub, a control board, a wiring harness extending from the control board to the electric component, a top panel, and a harness support assembly including a top cover interface coupled to the top panel, and a harness guide coupled to the top cover interface and the wash tub, wherein the harness guide directs the wiring harness along the vertical direction, lateral direction, and transverse direction.

### FIELD OF THE INVENTION

The present subject matter relates generally to washing machine appliances, or more specifically, to the harness supports within a washing machine appliance.

### BACKGROUND OF THE INVENTION

Washing machine appliances generally include a tub for containing water or wash fluid, e.g., water and detergent, bleach, and/or other wash additives. A basket is rotatably mounted within the tub and defines a wash chamber for receipt of articles for washing. During normal operation of such washing machine appliances, the wash fluid is directed into the tub and onto articles within the wash chamber of the basket. The basket or an agitation element can rotate at various speeds to agitate articles within the wash chamber, to wring wash fluid from articles within the wash chamber, etc. During a spin or drain cycle, a drain pump assembly may operate to discharge water from within sump.

Conventional washing machine appliances have various electrical components mounted to the tub, such as a motor for rotating the basket, and a wiring harness extends from a control board on the cabinet to the tub for powering the electrical components on the tub. Known mechanisms for securing wiring harness between the cabinet and the tub include one end of the wiring harness being fixed to the cabinet, and the other end of the wiring harness being fixed to the tub. Sufficient slack in the wiring harness between the fixed ends of the wiring harness may account for movement of the tub relative to the cabinet while the basket is spinning within the tub. Over time, securing the wiring harness in such a manner can lead to mechanical flex fatigue induced breakage, particularly at the locations where the wiring harness is fixed to the tub and cabinet, e.g., the singular stress point on the harness.

Accordingly, a washing machine appliance with an improved harness support is desirable. More specifically, improved systems to reduce singular stress point fatigue and thus increasing longevity of the harness support would be particularly beneficial.

### BRIEF DESCRIPTION OF THE INVENTION

Advantages of the invention will be set forth in part in the following description, or may be apparent from the description, or may be learned through practice of the invention.

In one example embodiment, a washing machine appliance is provided. The washing machine appliance, defining a mutually orthogonal vertical direction, lateral direction, and transverse direction, the washing machine appliance includes a wash tub positioned within a cabinet, an electric component mounted to the wash tub, a control board, a wiring harness extending from the control board to the electric component, a top panel, and a harness support assembly including a top cover interface coupled to the top panel, a harness guide coupled to the top cover interface and the wash tub, wherein the wiring harness is located therein, wherein the harness guide extends from above the top cover interface along one side of the wash tub along the vertical direction, and wherein the harness guide directs the wiring harness along the vertical direction, lateral direction, and transverse direction.

In another exemplary embodiment, a harness support assembly is provided. The harness support assembly, defining a mutually orthogonal vertical direction, lateral direction, and transverse direction, the harness support assembly includes a wiring harness configured to extend from a control board of a washing machine appliance to an electric component of the washing machine appliance, a top cover interface configured to be coupled to a top panel of the washing machine appliance, and a harness guide configured to be coupled to a top cover interface of the washing machine appliance and a wash tub of a washing machine appliance, wherein the wiring harness is located therein, wherein the harness guide extends from above the top cover interface to below the top cover interface along the vertical direction, and wherein the harness guide directs the wiring harness along the vertical direction, lateral direction, and transverse direction.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a washing machine appliance according to an example embodiment of the present subject matter with a door of the exemplary washing machine appliance shown in a closed position.

FIG. 2 provides a perspective view of the example washing machine appliance of FIG. 1 with the door of the example washing machine appliance shown in an open position.

FIG. 3 provides a side cross-sectional view of the example washing machine appliance of FIG. 1.

FIG. 4 provides a schematic view of select components of the example washing machine appliance of FIG. 1.

FIG. 5 provides a perspective view of a harness support assembly according to an example embodiment of the present subject matter.

FIG. 6 provides a perspective view of the example harness support assembly of FIG. 5 positioned on an example washing machine appliance.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

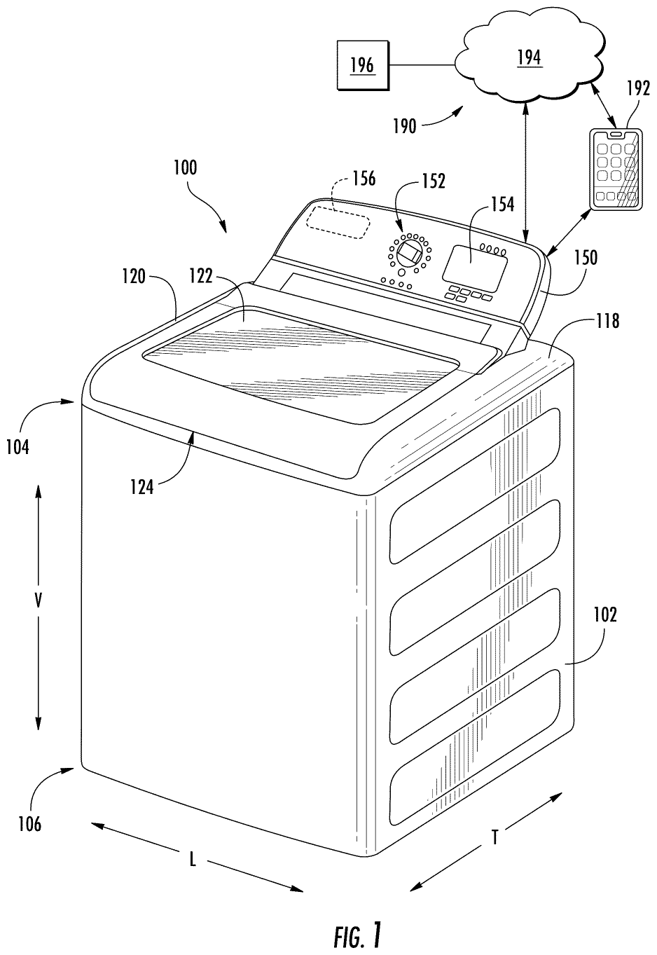

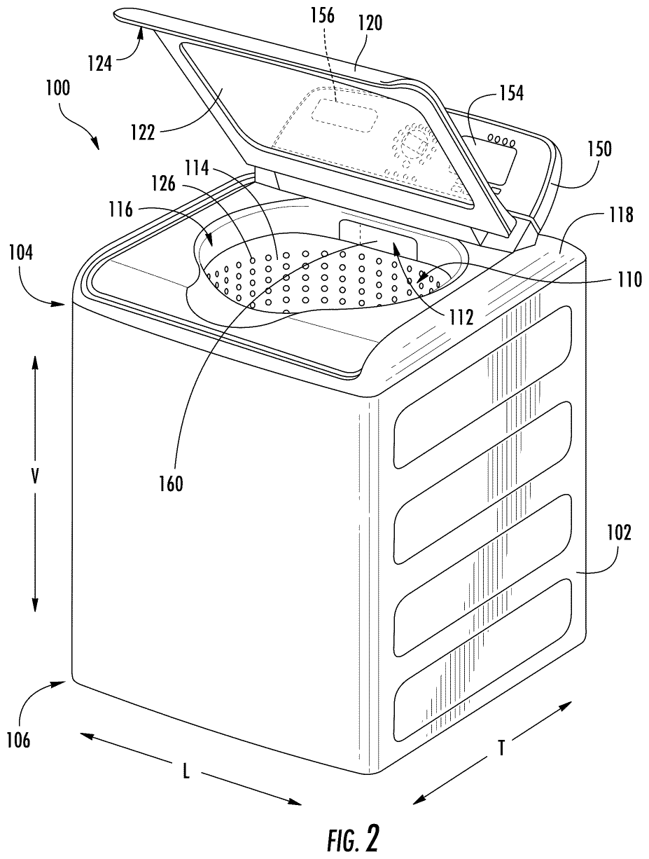

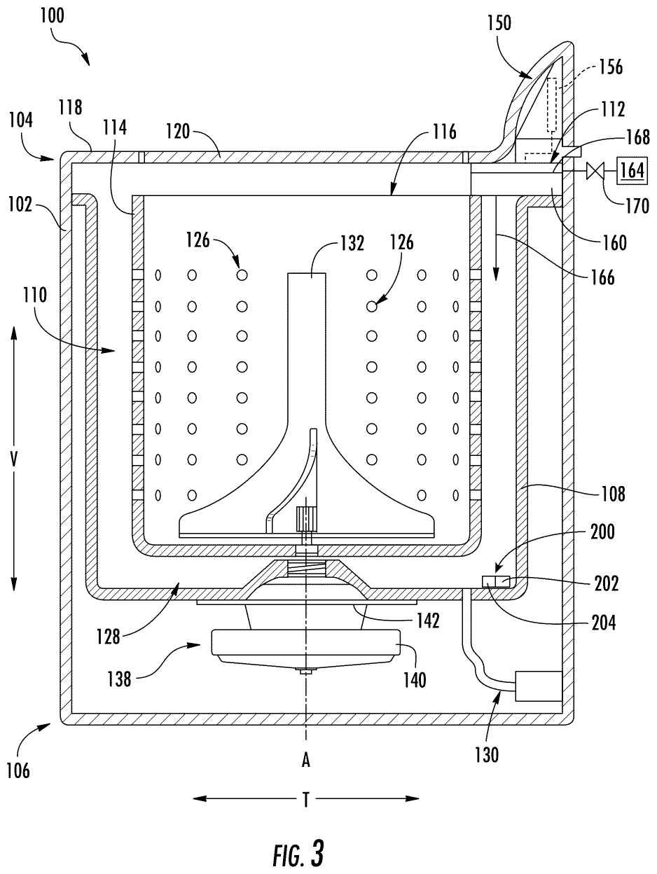

FIGS. 1 through 3 illustrate an exemplary embodiment of a vertical axis washing machine appliance 100. Specifically, FIGS. 1 and 2 illustrate perspective views of washing machine appliance 100 in a closed and an open position, respectively. FIG. 3 provides a side cross-sectional view of washing machine appliance 100. Washing machine appliance 100 generally defines a vertical direction V, a lateral direction L, and a transverse direction T, each of which is mutually perpendicular, such that an orthogonal coordinate system is generally defined.

While described in the context of a specific embodiment of vertical axis washing machine appliance 100, it should be appreciated that vertical axis washing machine appliance 100 is provided by way of example only. It will be understood that aspects of the present subject matter may be used in any other suitable washing machine appliance, such as a horizontal axis washing machine appliance. Indeed, modifications and variations may be made to washing machine appliance 100, including different configurations, different appearances, and/or different features while remaining within the scope of the present subject matter.

Washing machine appliance 100 has a cabinet 102 that extends between a top portion 104 and a bottom portion 106 along the vertical direction V, between a first side (left) and a second side (right) along the lateral direction L, and between a front and a rear along the transverse direction T. As best shown in FIG. 3, a wash tub 108 is positioned within cabinet 102, defines a wash chamber 110, and is generally configured for retaining wash fluids during an operating cycle. Washing machine appliance 100 further includes a primary dispenser or dispensing assembly 112 (FIG. 2) for dispensing wash fluid into wash tub 108.

In addition, washing machine appliance 100 includes a wash basket 114 that is positioned within wash tub 108 and generally defines an opening 116 for receipt of articles for washing. More specifically, wash basket 114 is rotatably mounted within wash tub 108 such that it is rotatable about an axis of rotation A. According to the illustrated embodiment, the axis of rotation A is substantially parallel to the vertical direction V. In this regard, washing machine appliance 100 is generally referred to as a “vertical axis” or “top load” washing machine appliance 100. However, it should be appreciated that aspects of the present subject matter may be used within the context of a horizontal axis or front load washing machine appliance as well.

As illustrated, cabinet 102 of washing machine appliance 100 has a top panel 118. Top panel 118 defines an opening (FIG. 2) that coincides with opening 116 of wash basket 114 to permit a user access to wash basket 114. Washing machine appliance 100 further includes a door 120 which is rotatably mounted to top panel 118 to permit selective access to opening 116. In particular, door 120 selectively rotates between the closed position (as shown in FIGS. 1 and 3) and the open position (as shown in FIG. 2). In the closed position, door 120 inhibits access to wash basket 114. Conversely, in the open position, a user can access wash basket 114. A window 122 in door 120 permits viewing of wash basket 114 when door 120 is in the closed position, e.g., during operation of washing machine appliance 100. Door 120 also includes a handle 124 that, e.g., a user may pull and/or lift when opening and closing door 120. Further, although door 120 is illustrated as mounted to top panel 118, door 120 may alternatively be mounted to cabinet 102 or any other suitable support.

As best shown in FIGS. 2 and 3, wash basket 114 further defines a plurality of perforations 126 to facilitate fluid communication between an interior of wash basket 114 and wash tub 108. In this regard, wash basket 114 is spaced apart from wash tub 108 to define a space for wash fluid to escape wash chamber 110. During a spin cycle, wash fluid within articles of clothing and within wash chamber 110 is urged through perforations 126 wherein it may collect in a sump 128 defined by wash tub 108. Washing machine appliance 100 further includes a pump assembly 130 (FIG. 3) that is located beneath wash tub 108 and wash basket 114 for gravity assisted flow when draining wash tub 108.

An impeller or agitation element 132 (FIG. 3), such as a vane agitator, impeller, auger, oscillatory basket mechanism, or some combination thereof is disposed in wash basket 114 to impart an oscillatory motion to articles and liquid in wash basket 114. More specifically, agitation element 132 extends into wash basket 114 and assists agitation of articles disposed within wash basket 114 during operation of washing machine appliance 100, e.g., to facilitate improved cleaning. In different embodiments, agitation element 132 includes a single action element (i.e., oscillatory only), a double action element (oscillatory movement at one end, single direction rotation at the other end) or a triple action element (oscillatory movement plus single direction rotation at one end, single direction rotation at the other end). As illustrated in FIG. 3, agitation element 132 and wash basket 114 are oriented to rotate about axis of rotation A (which is substantially parallel to vertical direction V).

As best illustrated in FIG. 3, washing machine appliance 100 includes a drive assembly or motor assembly 138 in mechanical communication with wash basket 114 to selectively rotate wash basket 114 (e.g., during an agitation or a rinse cycle of washing machine appliance 100). In addition, motor assembly 138 may also be in mechanical communication with agitation element 132. In this manner, motor assembly 138 may be configured for selectively rotating or oscillating wash basket 114 and/or agitation element 132 during various operating cycles of washing machine appliance 100.

More specifically, motor assembly 138 may generally include one or more of a drive motor 140 and a transmission assembly 142, e.g., such as a clutch assembly, for engaging and disengaging wash basket 114 and/or agitation element 132. According to the illustrated embodiment, drive motor 140 is a brushless DC electric motor, e.g., a pancake motor. However, according to alternative embodiments, drive motor 140 may be any other suitable type or configuration of motor. For example, drive motor 140 may be an AC motor, an induction motor, a permanent magnet synchronous motor, or any other suitable type of motor. In addition, motor assembly 138 may include any other suitable number, types, and configurations of support bearings or drive mechanisms.

Referring still to FIGS. 1 through 3, a control panel 150 with at least one input selector 152 (FIG. 1) extends from top panel 118. Control panel 150 and input selector 152 collectively form a user interface input for operator selection of machine cycles and features. A display 154 of control panel 150 indicates selected features, operation mode, a countdown timer, and/or other items of interest to appliance users regarding operation.

Operation of washing machine appliance 100 is controlled by a controller or processing device 156 that is operatively coupled to control panel 150 for user manipulation to select washing machine cycles and features. In response to user manipulation of control panel 150, controller 156 operates the various components of washing machine appliance 100 to execute selected machine cycles and features. According to an exemplary embodiment, controller 156 may include a memory and microprocessor, such as a general or special purpose microprocessor operable to execute programming instructions or micro-control code associated with methods described herein. Alternatively, controller 156 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software. Control panel 150 and other components of washing machine appliance 100 may be in communication with controller 156 via one or more signal lines or shared communication busses.

During operation of washing machine appliance 100, laundry items are loaded into wash basket 114 through opening 116, and washing operation is initiated through operator manipulation of input selectors 152. Wash basket 114 is filled with water and detergent and/or other fluid additives via primary dispenser 112. One or more valves can be controlled by washing machine appliance 100 to provide for filling wash tub 108 and wash basket 114 to the appropriate level for the amount of articles being washed and/or rinsed. By way of example for a wash mode, once wash basket 114 is properly filled with fluid, the contents of wash basket 114 can be agitated (e.g., with agitation element 132 as discussed previously) for washing of laundry items in wash basket 114.

After completion of the agitation cycle, washing machine appliance 100 may perform one or more rinse cycles. Specifically, according to an example embodiment, drain pump assembly 130 may drain the wash fluid from wash tub 108 and dispensing assembly 112 may dispense fresh water and/or a wash additive (such as fabric softener) into the wash tub. The load of clothes may then be agitated in the fresh water, e.g., to remove soil and detergent from load of clothes. After completion of the rinse cycle(s), drain pump assembly 130 may drain wash tub 108 and a spin cycle may be used to extract water from the clothes before the wash cycle is concluded.

Referring now specifically to FIGS. 2 through 3, dispensing assembly 112 of washing machine appliance 100 will be described in more detail. As explained briefly above, dispensing assembly 112 may generally be configured to dispense wash fluid to facilitate one or more operating cycles or phases of an operating cycle (e.g., such as a wash cycle or a rinse cycle). The terms “wash fluid” and the like may be used herein to generally refer to a liquid used for washing and/or rinsing clothing or other articles. For example, the wash fluid is typically made up of water that may include other additives such as detergent, fabric softener, bleach, or other suitable treatments (including combinations thereof). More specifically, the wash fluid for a wash cycle may be a mixture of water, detergent, and/or other additives, while the wash fluid for a rinse cycle may be water only and/or additional rinse additives.

As illustrated, dispensing assembly 112 may generally include a dispenser drawer 160 that is slidably mounted within cabinet 102 for receiving one or more wash additives or detergents. In this regard, a user may slide detergent drawer 160 out from cabinet 102 for supplying wash additives needed for a wash cycle. In this regard, detergent drawer 160 may define one or more detergent chambers. Detergent chambers may be generally configured for storing one or more wash additives for use during a washing cycle. For example, according to the illustrated embodiment, detergent drawer 160 defines a pre-wash chamber, a fabric softener chamber, a main wash chamber, and a detergent pod chamber. It should be appreciated that according to alternative embodiments, detergent drawer 160 may define other chambers for receiving other wash additives (e.g., such as bleach or other additives) while remaining within the scope of the present subject matter.

After additives have been supplied into detergent drawer 160, the user may slide detergent drawer 160 back into dispensing assembly 112 where a water supply 164 may selectively dispense fresh water to flush out one or more compartments of detergent drawer 160 and to create the flow of wash fluid 166 (FIG. 3). According to an example embodiment, a shower plate 168 may generally be positioned over detergent drawer 160 when detergent drawer 160 is inserted into dispensing assembly 112. According to an example embodiment, shower plate 168 may define a plurality of reservoirs that correspond to detergent chambers and includes a plurality of water supply apertures (not shown) or perforations for discharging the freshwater from water supply 164 down into one or more detergent chambers. In this manner, fresh water and/or additives may be showered or flooded within dispenser drawer 160 where they may be mixed prior to passing into wash tub 108 (e.g., as flow of wash fluid 166).

Further, washing machine appliance 100 may include a sensor assembly 200 that includes one or more sensors for providing useful information regarding a particular load or operating cycle of the appliance. This information may be used for improved appliance performance, as described in more detail herein. For example, sensor assembly 200 may include a turbidity sensor 202 and/or a conductivity sensor 204, e.g., for monitoring the contaminant level or soil level of wash fluid 166, e.g., in order to determine the cleanliness of the clothes, to determine appropriate rinse parameters, or to identify wash additives added to the flow of wash fluid 166. According to an example embodiment, turbidity sensor 202 may operate by using an emitter to emit a beam of light that is passed through wash fluid 166 and detecting the beam of light using a receiver. In this manner, the turbidity of wash fluid 166 may be estimated based on the distortion of the beam of light. According to an example embodiment, sensor assembly 200 may include a conductivity sensor 204 that is positioned in sump 128 and is configured for monitoring conductivity or other suitable parameters or conditions of the wash fluid 166. For example, conductivity sensor 204 may measure the electrical conductivity of the wash fluid 166.

As shown schematically in FIG. 3, dispensing assembly 112 may further include a valve assembly 170 including a plurality of freshwater supply valves positioned at a rear of shower plate 168 for providing flows of hot and/or cold water into shower plate 168, e.g., from water supply 164. Controller 156 may selectively operate supply valves to dispense water from water supply 164 into one or more reservoirs of shower plate 168. The flow of water may pass through shower plate 168 into one or more detergent chambers to flush the detergent into wash tub 108 as the flow of wash fluid 166 at a desired time of the wash cycle and at a desired fluid temperature.

After wash tub 108 is filled and the agitation phase of the wash cycle is completed, wash basket 114 can be drained, e.g., by drain pump assembly 130. Laundry articles can then be rinsed by again adding fluid to wash basket 114 depending on the specifics of the cleaning cycle selected by a user. The impeller or agitation element 132 may again provide agitation within wash basket 114. One or more spin cycles may also be used as part of the cleaning process. In particular, a spin cycle may be applied after the wash cycle and/or after the rinse cycle in order to wring wash fluid from the articles being washed. During a spin cycle, wash basket 114 is rotated at relatively high speeds to help wring fluid from the laundry articles through perforations 126. During or prior to the spin cycle, drain pump assembly 130 may operate to discharge wash fluid from wash tub 108, e.g., to an external drain. After articles disposed in wash basket 114 are cleaned and/or washed, the user can remove the articles from wash basket 114, e.g., by reaching into wash basket 114 through opening 116.

Referring still to FIG. 1, a schematic diagram of an external communication system 190 will be described according to an exemplary embodiment of the present subject matter. In general, external communication system 190 is configured for permitting interaction, data transfer, and other communications between washing machine appliance 100 and one or more external devices. For example, this communication may be used to provide and receive operating parameters, user instructions or notifications, performance characteristics, user preferences, or any other suitable information for improved performance of washing machine appliance 100. In addition, it should be appreciated that external communication system 190 may be used to transfer data or other information to improve performance of one or more external devices or appliances and/or improve user interaction with such devices.

For example, external communication system 190 permits controller 156 of washing machine appliance 100 to communicate with a separate device external to washing machine appliance 100, referred to generally herein as an external device 192. As described in more detail below, these communications may be facilitated using a wired or wireless connection, such as via a network 194. In general, external device 192 may be any suitable device separate from washing machine appliance 100 that is configured to provide and/or receive communications, information, data, or commands from a user. In this regard, external device 192 may be, for example, a personal phone, a smartphone, a tablet, a laptop or personal computer, a wearable device, a smart home system, or another mobile or remote device.

In addition, a remote server 196 may be in communication with washing machine appliance 100 and/or external device 192 through network 194. In this regard, for example, remote server 196 may be a cloud-based server 196, and is thus located at a distant location, such as in a separate state, country, etc. According to an exemplary embodiment, external device 192 may communicate with a remote server 196 over network 194, such as the Internet, to transmit/receive data or information, provide user inputs, receive user notifications or instructions, interact with or control washing machine appliance 100, etc. In addition, external device 192 and remote server 196 may communicate with washing machine appliance 100 to communicate similar information.

In general, communication between washing machine appliance 100, external device 192, remote server 196, and/or other user devices or appliances may be carried using any type of wired or wireless connection and using any suitable type of communication network, non-limiting examples of which are provided below. For example, external device 192 may be in direct or indirect communication with washing machine appliance 100 through any suitable wired or wireless communication connections or interfaces, such as network 194. For example, network 194 may include one or more of a local area network (LAN), a wide area network (WAN), a personal area network (PAN), the Internet, a cellular network, any other suitable short-or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 190 is described herein according to an exemplary embodiment of the present subject matter. However, it should be appreciated that the exemplary functions and configurations of external communication system 190 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

While described in the context of a specific embodiment of vertical axis washing machine appliance 100, using the teachings disclosed herein it will be understood that vertical axis washing machine appliance 100 is provided by way of example only. Other domestic appliances, e.g., washing machine appliances, having different configurations, different appearances, and/or different features may also be utilized with the present subject matter as well, e.g., horizontal axis washing machine appliances and front load washing machine appliances. In addition, aspects of the present subject matter may be utilized in other domestic appliances that include but are not limited to a combination washer/dryer appliance and/or a separate dryer appliance.

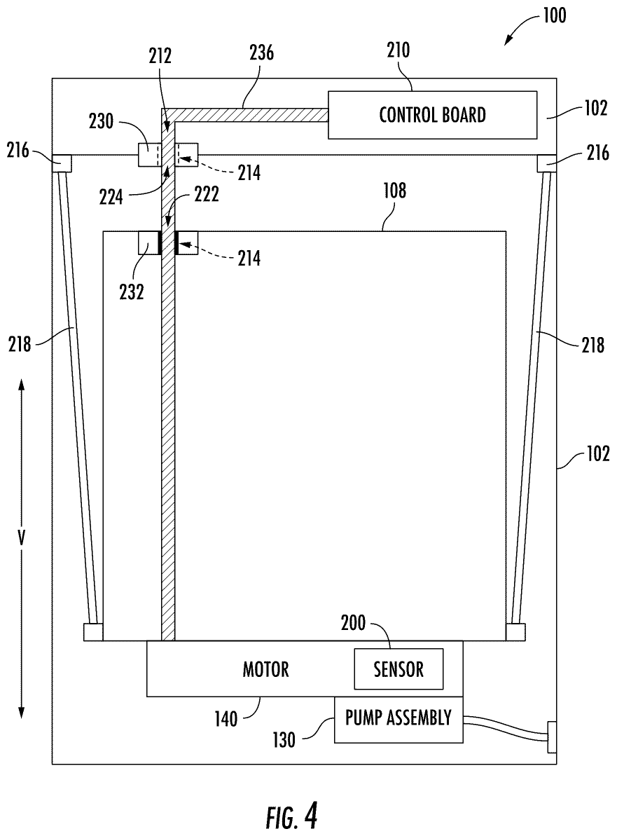

FIGS. 4 through 6 illustrate an example embodiment of a harness support assembly 230. Referring specifically to FIG. 4, washing machine appliance 100 includes a control board 210, a harness support assembly 230, and a wiring harness 212. Control board 210 is positioned within the cabinet 102. In one example embodiment, the control board may be positioned away from the wash tub 108. Control board 210 may also be spaced from the wash tub 108 while still within the cabinet 102. Wiring harness 212 electrically connects control board 210 with one or more electrical components on wash tub 108, such as motor assembly 138, drive motor 140, or sensor assembly 200. Thus, e.g., wiring harness 212 may extend between control board 210 and the one or more electrical components on wash tub 108. As discussed in greater detail below, harness support assembly 230 constrains motion of wiring harness 212, e.g., between cabinet 102 and wash tub 108 as wash basket 114 rotates within wash tub 108 such that wash tub 108 moves within cabinet 102 on a vibration damping suspension system 218, which is attached to the cabinet 102 via a plurality of brackets 216.

Control board 210 may include one or more processors and a memory. In one example embodiment, the control board 210 and the controller 156 may be the same component. In another example embodiment, the control board 210 may be operatively coupled to the controller 156. The processor(s) of control board 210 can be any suitable processing device, such as a microprocessor, microcontroller, integrated circuit, or other suitable processing device. The memory of control board 210 can include any suitable computing system or media, including, but not limited to, non-transitory computer-readable media, RAM, ROM, hard drives, flash drives, or other memory devices. The memory of control board 210 can store information accessible by the processor(s) of control board 210, including instructions that can be executed by the processor(s) to control various components of washing machine appliance 100 to provide appliance functionality and data. Thus, the combination of one or more processors and memory may correspond to a controller configured to implement various programs or methods to operate washing machine appliance 100. Input/output (“I/O”) signals may be routed between control board 210 and various operational components of washing machine appliance 100, including the one or more electrical components on wash tub 108, along wiring harness 212 within washing machine appliance 100. Wiring harnesses 212 may include a plurality of conductive wires.

A first portion 222 of wiring harness 212 is fixed to wash tub 108. Thus, e.g., first portion 222 of wiring harness 212 may be fixed relative to wash tub 108 as wash basket 114 rotates within wash tub 108 such that wash tub 108 moves within cabinet 102 on the vibration damping suspension system 218. In contrast, the first portion 222 of wiring harness 212 may move relative to cabinet 102 as wash basket 114 rotates within wash tub 108 such that wash tub 108 moves within cabinet 102 on the vibration damping suspension system 218. As a particular example, first portion 222 of wiring harness 212 may be fixed to wash tub 108 with a grommet 232. First, grommet 232 may be overmolded onto the first portion 222 of wiring harness 212. Then, grommet 232 may be suitably fixed to wash tub 108, e.g., with adhesive, fasteners, clips, etc. In alternative example embodiments, first portion 222 of wiring harness 212 may be received within a through hole 214 of grommet 232, and an adhesive may be used to fix first portion 222 of wiring harness 212 to grommet 232.

Harness support assembly 230 is mounted to cabinet 102. In one example embodiment, the harness support assembly 230 is mounted to the top panel 118 of the cabinet 102. Thus, e.g., harness support assembly 230 may be fixed relative to cabinet 102 as wash basket 114 rotates within wash tub 108 such that wash tub 108 moves within cabinet 102 on the vibration damping suspension system 218. In contrast, wash tub 108 may move relative to harness support assembly 230 as wash basket 114 rotates within wash tub 108 such that wash tub 108 moves within cabinet 102 on the vibration damping suspension system 218.

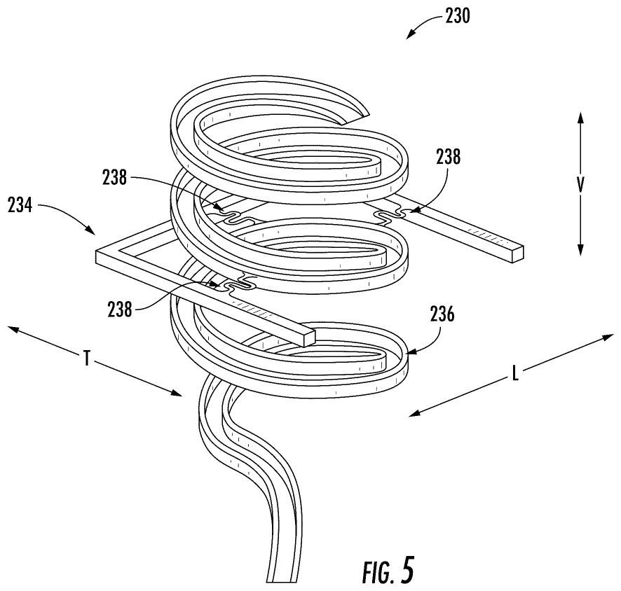

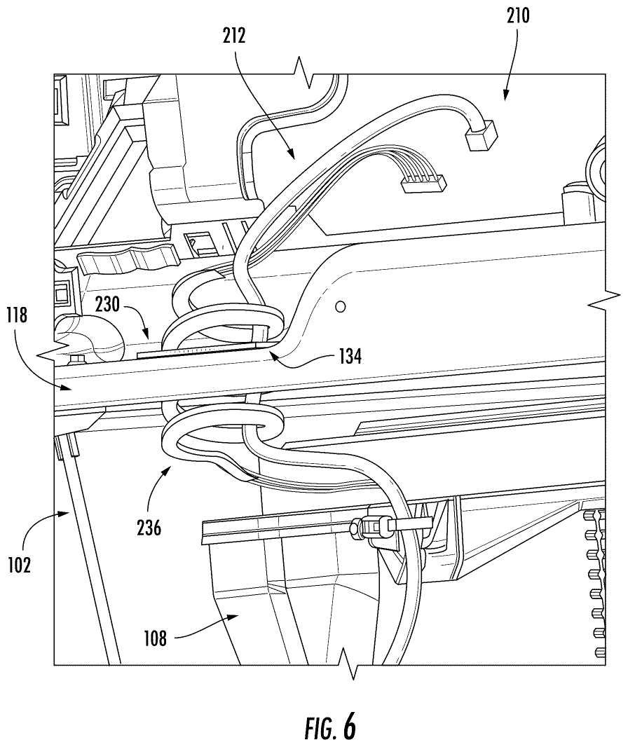

As noted above, harness support assembly 230 constrains motion of wiring harness 212 between cabinet 102 and wash tub 108. Harness support assembly 230 constrains motion along the vertical direction V, lateral direction L, and transverse direction T. In one example embodiment, the constraint of motion also is applied to the portion of the wiring harness between cabinet 102 and the control board 210. As shown in FIG. 4, a second portion 224 of wiring harness 212 is received within harness support assembly 230 such that wiring harness 212 is slidable within harness support assembly 230, and more specifically a harness guide 236 (FIGS. 5 and 6). Thus, wiring harness 212 may slide within harness support assembly 230 as wash basket 114 rotates within wash tub 108 such that wash tub 108 moves within cabinet 102 on the vibration damping suspension system 218. As shown in FIG. 4, harness support assembly 230 may be positioned over wash tub 108 within cabinet 102. Thus, wiring harness 212 may be slidable along the vertical direction V within harness support assembly 230. Conversely, harness support assembly 230 may constrain motion of wiring harness 212 within harness support assembly 230 in a plane that is perpendicular to the vertical direction V.

Referring now generally to FIGS. 5 and 6, an example harness support assembly 230 is provided. In one example embodiment, the harness support assembly 230 defines a mutually orthogonal vertical direction V, lateral direction L, and transverse direction T. Harness support assembly 230 may include a wiring harness 212 configured to extend from the control board 210 to an electric component of the washing machine appliance 100. Further, the harness support assembly includes a top cover interface 234 extending along the transverse direction T and lateral direction L coupled to the top panel 118 of the cabinet 102 of washing machine appliance 100. Harness support assembly 230 also includes a harness guide 236 coupled to the top cover interface 234 and the wash tub of a washing machine appliance 100. In one example embodiment, the connection between the top cover interface 234 and the harness guide 236 is a rigid connection. In another example embodiment, the connection between the wash tub 108 and the harness guide 236 is a rigid connection.

The wiring harness 212 is positioned inside the harness guide 236. Additionally, the harness guide 236 extends from above the top cover interface 234 to below the top cover interface 234 along the vertical direction V. The harness guide 236 directs the wiring harness 212 along the vertical direction V, lateral direction L, and transverse direction T.

As illustrated in FIGS. 5 and 6, the harness guide 236 may be helical shaped. The circular portion of the helical shape extends along the transverse direction T and lateral direction L. Further, the spiral of the helical shape extends along the transverse direction. The helical shape of the harness guide 236 prevents stress placed on the harness support assembly 230 by the movement of the wash tub 108 within the cabinet 102 during operation of the washing machine appliance to be on any singular point thereon. Although only a helical shape is illustrated, there exist other embodiments where the purpose of preventing stress on a singular point is accomplished. The degree of spiral within the helical shape may be considerably spaced out or substantially compressed. In other example embodiments, these shapes for the harness guide 236 include other shapes without 90-degree angles, which may include multiple attachment points and/or grommets on the wash tub 108, cabinet 102, top panel 118, or some combination thereof. Other possible shapes include but are not limited to a wave pattern, oscillating curves, and linear shape with material flexibility.

Regarding the material of the harness guide 236, in one example embodiment, the harness guide 236 may be plastic. Some example materials include PVC, polyethylene, and polypropylene, or some combination thereof. Additionally or alternatively, nylon or polyester may be added for protective sleeves, if necessary. Additionally or alternatively, under certain conditions, the use of rubber, Teflon, or silicone may be included in the material composition. In another example embodiment, any suitable material may be utilized to achieve the desired resilience to stress placed on the harness guide 236.

The harness support assembly 230 may further include a plurality of interface springs 238 coupled to the top panel 118 of the washing machine appliance 100. This further allows the distribution of stress placed on the harness support assembly 230 to not be placed on any singular point and instead be distributed across the harness support assembly 230.

The harness guide 236 may include a bottom and a plurality of sides coupled to the bottom, configured to restrict movement of the wiring harness 212 outside of the harness guide 236. In this example embodiment, the top of the harness guide may be open (FIG. 5). However, in an alternative embodiment, the harness guide 236 may include a top coupled to the plurality of sides, creating an enclosure around the wiring harness 212. This enclosure may include the bottom, plurality of sides, and top as separate components or it may include a single enclosure such as a conduit, e.g., a wiring conduit, as shown in FIG. 6.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A washing machine appliance, defining a mutually orthogonal vertical direction, lateral direction, and transverse direction, the washing machine appliance comprising:
a wash tub positioned within a cabinet;
an electric component mounted to the wash tub;
a control board;
a wiring harness extending from the control board to the electric component;
a top panel; and
a harness support assembly comprising:
a top cover interface coupled to the top panel; and
a harness guide coupled to the top cover interface and the wash tub,
wherein the wiring harness is located therein,
wherein the harness guide extends from above the top cover interface along one side of the wash tub along the vertical direction, and
wherein the harness guide directs the wiring harness along the vertical direction, lateral direction, and transverse direction.

2. The washing machine appliance of claim 1, wherein the harness guide is a helical shape,
wherein the helical shape extends in the transverse direction and lateral direction, and
wherein the helical shape spirals along the vertical direction.

3. The washing machine appliance of claim 1, wherein the harness support assembly further comprises:
a plurality of interface springs coupled to the top panel.

4. The washing machine appliance of claim 1, wherein the electric component is a drive motor.

5. The washing machine appliance of claim 1, wherein the harness guide comprises:
a bottom; and
a plurality of sides coupled to the bottom, configured to restrict movement of the wiring harness outside of the harness guide.

6. The washing machine appliance of claim 5, the harness guide further comprising:
a top coupled to the plurality of sides.

7. The washing machine appliance of claim 1, wherein the harness guide comprises:
a wiring conduit.

8. The washing machine appliance of claim 1, wherein the control board is positioned within the cabinet and away from the wash tub.

9. The washing machine appliance of claim 1, wherein the harness guide is coupled to the top cover interface via a rigid connection.

10. The washing machine appliance of claim 1, wherein the harness guide is coupled to the wash tub via a rigid connection.

11. A harness support assembly, defining a mutually orthogonal vertical direction, lateral direction, and transverse direction, the harness support assembly comprising:
a wiring harness configured to extend from a control board of a washing machine appliance to an electric component of the washing machine appliance;
a top cover interface configured to be coupled to a top panel of the washing machine appliance; and
a harness guide configured to be coupled to a top cover interface of the washing machine appliance and a wash tub of a washing machine appliance,
wherein the wiring harness is located therein,
wherein the harness guide extends from above the top cover interface to below the top cover interface along the vertical direction, and
wherein the harness guide directs the wiring harness along the vertical direction, lateral direction, and transverse direction.

12. The harness support assembly of claim 11, wherein the harness guide is helical shaped wherein the harness guide is a helical shape,
wherein the helical shape extends in the transverse direction and lateral direction, and
wherein the helical shape spirals along the vertical direction.

13. The harness support assembly of claim 11, wherein the harness support assembly further comprises:
a plurality of interface springs configured to be coupled to the top panel of the washing machine appliance.

14. The harness support assembly of claim 13, wherein the electric component of the washing machine appliance is a drive motor.

15. The harness support assembly of claim 11, wherein the harness guide comprises:
a bottom; and
a plurality of sides coupled to the bottom, configured to restrict movement of the wiring harness outside of the harness guide.

16. The harness support assembly of claim 15, the harness guide further comprising:
a top coupled to the plurality of sides.

17. The harness support assembly of claim 11, wherein the harness guide comprises:
a wiring conduit.

18. The harness support assembly of claim 11, wherein the control board of the washing machine appliance is positioned within a cabinet of the washing machine appliance and away from the wash tub of the washing machine appliance.

19. The harness support assembly of claim 11, wherein the harness guide is coupled to the top cover interface via a rigid connection.

20. The harness support assembly of claim 11, wherein the harness guide is configured to be coupled to the wash tub cover via a rigid connection.
